(19) United States
(12) Patent Application Publication
(10) Pub. No.: US 2009/0199094 A1
(43) Pub. Date: Aug. 6, 2009

(54) System and method for rewards integration in a computer system

(75) Inventors: Kelly Jurgens, Charlotte, NC (US); Dean Nolan, Charlotte, NC (US); Steve Boehm, Charlotte, NC (US)

Correspondence Address: Wells Fargo;c/o K& L Gates, Hearst Tower, 47th Floor, 214 North Tryon Street, Charlotte, NC, 28202, US

(73) Assignee: Wachovia Corporation, Charlotte, NC (US)

(21) Appl. No.: 12/012,659

(22) Filed: Feb. 5, 2008

(51) Int. Cl. G06F 3/00

(52) U.S. Cl. 715/700

(57) ABSTRACT

A system and method of integrating financial information and rewards data in a computer system of a financial institution such as an online banking computer system. The method generally comprises providing to a customer of a financial institution access to a computer system comprising financial information and rewards data, and presenting the financial information and rewards data to the customer of the financial institution in a presentation layer viewable by the customer.

### FIELD OF THE INVENTION

The present invention relates to a system and a method for rewards integration in a computer system of a financial institution, more particularly for rewards integration in an online banking computer system of a financial institution.

### BACKGROUND OF THE INVENTION

Financial transactions have become dominated by credit and debit cards as opposed to cash based transactions. As a result, the ability to transact business and attend to financial matters has become computer based with the world wide web providing access to all types of financial information and data. It has also provided the ability for a consumer to make purchases using credit and debit cards electronically online via a virtual merchant.

FIG. 1 illustrates a typical payment card based transaction. A purchaser who may be, for example, a bank customer makes a purchase at a point of sale (POS) merchant terminal using a payment card such as a credit or debit card. The credit or debit card transaction is settled through a payment card network such as VISA, MasterCard, or American Express. The payment card network then accesses a source of funds for use in securing the purchase.

Thus, a very extensive and highly regulated industry has evolved around the use of credit instruments such as credit and debit cards. Financial institutions such as banks and credit card companies encourage consumers to use credit and debit cards to make purchases.

There is increasing competition in the marketplace to obtain new cardholders. Numerous financial institutions and retail merchants who offer credit and debit cards compete to attract and retain cardholders. Thus, an entire industry within the financial services industry has evolved around encouraging credit and debit cardholders to use these instruments by rewarding card holders through rewards-based programs.

Most consumers have credit and debit cards, bank accounts, loans, and other financial obligations with numerous financial institutions. Thus, a problem arises for a consumer in trying to assimilate and process all of the financial information pertinent to their spending habits and in trying to optimize the rewards that can be obtained via their card purchasing habits. Failure to recognize and understand the rewards and other sources of financial information can lead to lapse of rewards benefits to which a customer may be entitled.

After a point of sale (POS) transaction as shown in FIG. 1, a cardholder often has questions that relate to these various sources of financial information. For example, a first question often is, “What is my balance or transaction history?” A second question often with respect to credit or debit cards that offer rewards points to encourage further spending on these instruments is, “How many points do I have?” Further questions often arise such as, “How am I spending? How can I earn more rewards points?”

For the answer to the first question about the account balance or transaction history, the cardholder must either physically go to its bank or go to its banking center web channel or interface such as a financial institution online banking website. Among the information typically provided by online banking is balances, checks, ATM withdrawals, online bill payments from internal banking systems, and card transactions from debit card and credit card purchases.

To answer the second question of “How many points do I have?,” a customer has to go to the website for its rewards program to get the rewards points balance. A rewards points tracking device may track point balances, points earned for each transaction, points adjustments and redemptions. In answer to the other questions of “How am I spending? How can I earn more points?,” a cardholder has to seek out other financial management tools. A customer must manually download information or software from banks or other financial institutions or manually key in data to create spending by category and set budget goals.

For example, as indicated in FIG. 2, there are multiple existing financial information sources known in the financial services industry that a consumer would have to access one at a time. For example, these include, but are not limited to, online banking and bill pay; rewards engines and web channels; and data aggregation and spending patterns.

Thus, there is an unfilled need for a system and method that will assist a customer of a financial institution in assimilating its financial information and the rewards associated therewith.

### SUMMARY OF THE INVENTION

The present invention is for a system and method of integrating financial information and rewards data in a computer system of a financial institution. Preferably, the computer system is an online banking computer system. The method generally comprises providing to a customer of a financial institution access to a computer system comprising financial information and rewards data, and presenting the financial information and rewards data to the customer of the financial institution in a presentation layer viewable by the customer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram of a known method for a payment based card transaction.

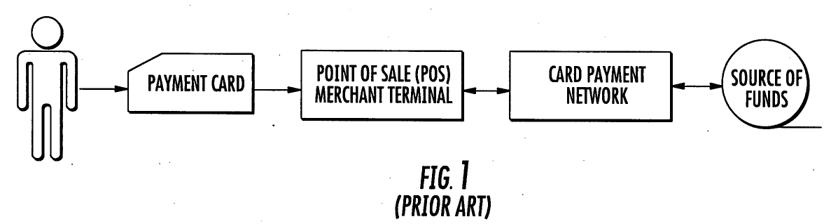

FIG. 2 is a flow diagram of the known process by which a customer assimilates and compiles its financial information from multiple sources.

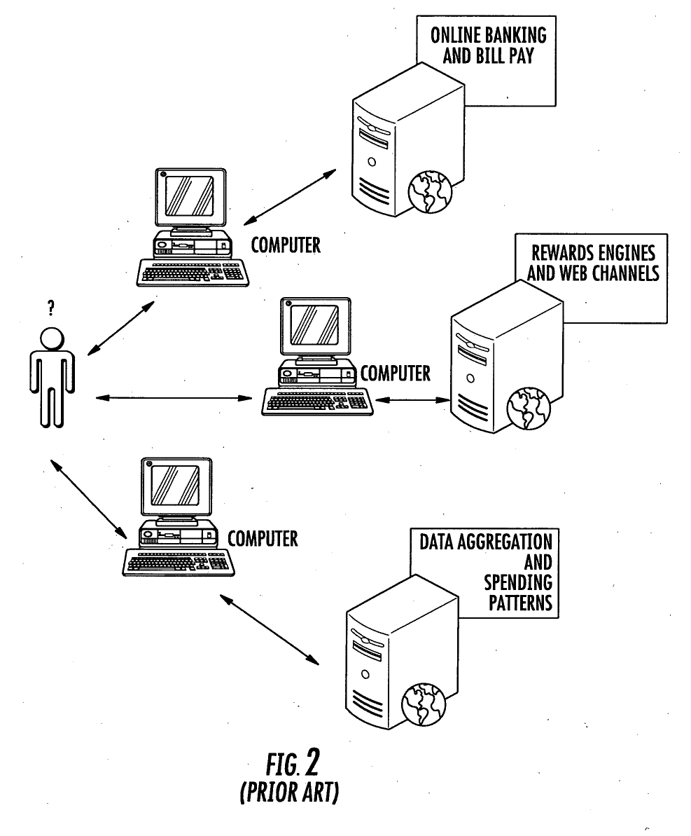

FIG. 3 is a flow diagram generally illustrating the system and method of the present invention for providing to a customer of a financial institution with a single point of access to a computer system comprising collective financial information of the customer.

FIG. 4 is a flow diagram of a user using a web interface to access a webserver of a financial institution in accordance with the system and method of the present invention.

FIG. 5 is a flow diagram of a representative computer network infrastructure that supports the system and method of the present invention.

### DETAILED DESCRIPTION OF THE INVENTION

The following detailed description of the present invention is merely exemplary in nature and is in no way intended to limit the invention, its application, or uses. The present invention generally relates to a computer system and method for rewards integration with online banking. The present invention has broad potential application and utility, which is contemplated to be adaptable to a wide range of entities. For example, it is contemplated that the system and method of the present invention would be beneficial for use by any financial institution including, but without limitation, a bank, credit union, savings and loan, or other entity that provides financial services or information. Additionally, it is contemplated that the system and method of the present invention would be equally beneficial, for example, for the retail or other industries. The following description is provided herein solely by way of example for purposes of providing an enabling disclosure of the invention, but does not limit the scope or substance of the invention.

The system and method of the present invention provides a customer of a financial institution with a single point of access to collective financial information of the customer in a computer network. More particularly, the system and method of the present invention provides a customer of a financial institution with a single point of access to computer system of the financial institution that integrates not only financial information from multiple sources, but also integrates rewards data of the customer within online banking functionality. The term “online banking,” as used herein, encompasses banking services, information, and data.

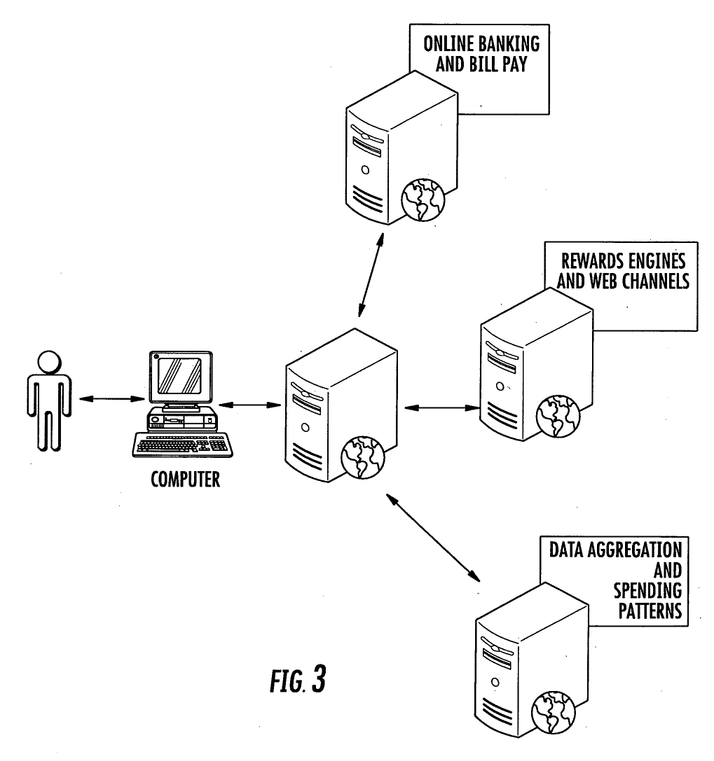

Referring to the drawings, FIG. 3 is a flow diagram generally illustrating the system and method of the present invention for providing a customer of a financial institution with a single point of access to a computer system comprising collective financial information of the customer. More particularly, the system and method of the present invention provides a customer of a financial institution with a single point of access to a computer system integrating online banking and rewards data of the customer in a computer network. As shown in FIG. 3, the sources of financial information include, but are not limited to, online banking and bill pay, rewards engines and web channels, and data aggregation and spending patterns. The financial information provided by these sources of information is compiled and presented online in a presentation layer to the customer. The system and method of the present invention presents the compiled financial information to the customer using a variety of computer software application tools that are designed to utilize the compiled financial information and to present it to the customer of the financial institution online in a presentation layer.

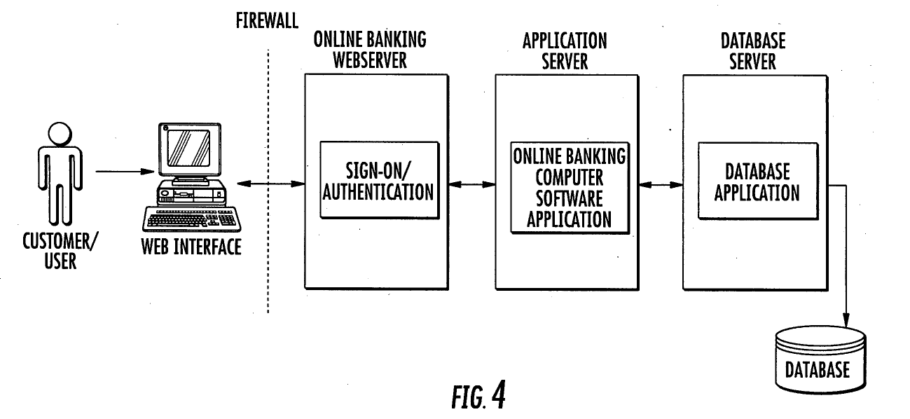

FIG. 4 further illustrates the system and method of the present invention. In particular, FIG. 4 is a flow diagram illustrating a user using a web interface to access an online banking webserver of a financial institution in accordance with the system and method of the present invention. The user, for example, is a person, entity, device or computer, and is a customer or other authorized user of a financial institution. A web interface is a means to access authenticated space. Examples of a web interface include, but are not limited to, a personal computer (PC), a personal data assistant (PDA), or any other device for accessing authenticated space such as a website or webserver.

As shown in FIG. 4, the user presents its user identification (ID) and password credentials for purposes of sign-on and authentication. A firewall may be present between the web interface and the authenticated space for security purposes. The online banking webserver is present within the authenticated space. The online banking webserver typically comprises an html server and a sign-on/authentication service such that a user can authenticate once and have access to multiple computer software applications.

The webserver is communicatively connected to an application server. The application server comprises an online banking computer software application. The online banking software application integrates online banking functionality and rewards data in a single presentation layer. The online banking computer software application of the application server is communicatively connected to a database server. The database server comprises a database computer software application. The database computer software application is used, for example, to extract data. An example of a commercially available product that is suitable for use with the present invention includes, but is not limited to, WebSphere from IBM Corporation.

The system and method of the present invention further comprises a presentation layer that is accessible and viewable by the user using the web interface of the user after gaining access to the authenticated space. The presentation layer presents the extracted data from the database server. Data available to extract for presentation includes, but is not limited to, credit card data, debit card data, Demand Deposit Account (DDA) data, online banking data, bill pay data, and rewards data. Credit card data includes, but is not limited to, card number, account status, card type, points earn rate, transactions, rewards points earned per transaction, merchant category code (MCC), credit line, balance, and rewards points balance. Debit card data includes, but is not limited to, card number, account status, card type, enrollment status, points earn rate, transactions, rewards points earned per transaction, MCC, and rewards points balance. DDA data includes, but is not limited to, account status, transactions (ACH, check, ATM withdrawal transfers), balance, and authorized users. Online banking and bill pay data includes, but is not limited to, sign-on/authentication, account entitlements, online bill pay subscriber, online bill pay payees, online bill pay transactions/amounts. Rewards data includes, but is not limited to, enrollment status, points balance, earn rate, bonus points/adjustments, redemptions, and points earned at the transactional level.

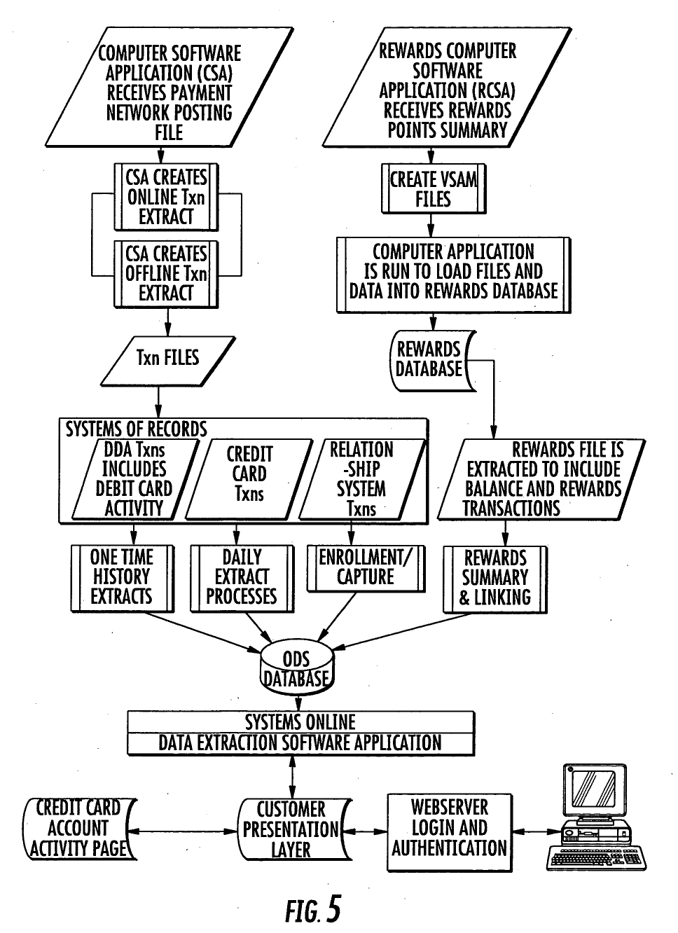

FIG. 5 is a flow diagram of a representative computer network infrastructure that supports the system and method of the present invention. As shown in FIG. 5, a computer system application (CSA) takes in debit card transactions once debit activity posts by receiving a payment network posting file. The CSA creates an online transaction extract data file. The online transaction extract data file is typically comprised of data in the instance where the customer signs for the purchase. The CSA also creates an offline transaction extract data file. The offline transaction extract data file is typically comprised of data in the instance where a personal identification number (PIN) of the customer is used in the transaction. The transaction files are then sent to systems of record. Systems of record are the accounting systems within the financial institution that match account numbers and transactions, post transactions to the accounts and calculate balances for each customer account. Examples of systems of record include, but are not limited to, demand deposit account (DDA) transactions (such as checks, debit card activity and online bill pay activity), credit card (CC) transactions, and relationship (RL) information. From the systems of record, data is compiled into electronic data files including, but not limited to, a one-time history extract data file, a daily extract process data file, and an enrollment/capture data file.

Also, as shown in FIG. 5, a Rewards Computer Software Application (RCSA) receives summary rewards points from the a rewards provider. This information typically includes, but is not limited to, debit card and credit card activity. The RCSA creates a virtual storage access method (VSAM) file. A VSAM file is a type of data file that is typically found in the financial services industry. A computer job is executed to load the VSAM files and data into the rewards database. The rewards database is the repository for rewards information. A rewards file is created and referred to herein as the rewards summary and linking data file.

The data files which include, but are not limited to, the one time history extracts data file, the daily extract processes data file, the enrollment/capture data file, and the rewards summary and linking data file, are sent to a database. The database is referred to herein as the online data store (ODS) database. The ODS database is communicatively connected to a database server which comprises a data extraction software application to extract or pull data from the ODS database and an extraction database to store the extracted data. An example of a commercially available computer software application used to extract data from the ODS database is WebSphere from IBM Corporation. Another computer software application for use in the system of the present invention, referred to herein as “Systems Online,” is a program that receives the data from the ODS database for online banking customers. Systems Online organizes the data such that it may be readily retrieved if called for by the data extraction software application.

From the database server, data is accessible to the presentation layer via the systems online application. The presentation layer also draws upon information from a data processor such as the credit card account activity pages to obtain credit instrument data and account activity information for credit card customers. As indicated in FIG. 4, a customer having access to a web interface can sign-on and once authenticated sign on to access the presentation layer and the full breadth of data and information linked to the customer's banking account and other financial information, credit/debit instruments, and rewards activity.

The application server through a computer software application for online banking provides computer software application tool(s) to a user. An example of a computer software application tool of the system and method of the present invention is a “rewards mini-statement” tool. A user such as debit or credit cardholder is provided with a rewards mini-statement tool to incorporate the rewards earned. The rewards mini-statement is compiled from data received in the RCSA and the process to receive, store and incorporate the data into the online banking computer software application and provides online computer access to such mini-statement within the online banking screens of a customer account of a financial institution. Data for the rewards mini-statement is extracted from the ODS database. For example, in the case of rewards points, the rewards mini-statement comprises a calculation which is the sum of points from the prior month, plus points earned month to date, then plus or minus (±) bonus points and adjustments (such as goodwill points or returns), minus points redeemed month to date. The sum equals the rewards points available for redemption.

Another computer software tool in accordance with the system and method of the present invention is a “transactional earn” computer software application tool. The “transactional earn” computer software application tool is used to list transactions on account activity screens for a customer's transactions. This tool is used to display the amount of reward points earned for a corresponding transaction. The “transactional earn” tool enables a customer to view if the customer has earned any rewards for a given transaction and, if so, how much of a reward the customer has earned for each transaction. For example, it may list how many rewards points have been earned for a given transaction.

Another computer software application tool of the system and method of the present invention is referred to herein as a “zero points hyperlink” computer software application tool. Within the account activity screens, if in the case of rewards points, if no points were earned for a given transaction, an information icon is displayed on the presentation layer. When the customer selects the icon, a message is displayed for the customer informing the customer as to why the transaction was not a transaction eligible for rewards and provides information on how the customer could have earned more points.

Another computer software application tool in accordance with the system and method of the present invention provides various vehicles for reporting to the instrument holder how many points the customer has earned by various transaction types. Transaction types include, but are not limited to, ATM withdrawal, check, ACH, online bill payment, debit instrument purchase (with PIN or with signature), and credit instrument purchase.

The points earned per instrument type are reported using this tool. Rules may be set by a customer governing the funding of the purchase before a purchase is made. Rules are set by a number of methods including, but not limited to, rules being set by a financial institution on behalf of the customer, rules being set by the customer through the online banking, ATMs, IVR, or other applications of a financial institution.

Another computer software application tool in accordance with the system and method of the present invention referred to herein as the “purchases pie chart” application tool. It is used to report in graphical form to an instrument holder how many points the customer has earned by various transaction types. Rules governing the funding of the purchase are determined during the transaction process. After the purchases and transactions are made by the customer, the purchases pie chart displays by transaction type (credit card, debit card, checks, ATM, ACH, online bill pay, etc.) how many dollars were spent and how many rewards points were earned for each type. This information enables a customer to better understand the rules governing the awarding of points and the points that they earned by transaction type.

There are numerous advantages of the system and method of the present invention. Among the advantages is convenience to an instrument holder. Another advantage of the system and method of the present invention is that by providing rewards information within online banking, a customer gains more visibility into their rewards points using the customer's primary channel of choice, typically its financial institution's website. By providing better spending data, customers can leverage transactional data within a financial institution's website without manual downloading or keying data.

Still yet further advantages of the system and method of the present invention include, but are not limited to, promoting and improving card adoption, activation, usage and retention across the portfolio of banking card services offered; enhancing customer reporting and accessibility to rewards information; providing a customer with better information on spending for increased control over patterns; enhancing customer experience by providing better information on payment choices across multiple payment options; and promoting and increasing usage of banking functionality such as online bill pay and across channel usage for other financial institution services.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for integrating financial information and rewards data in a computer system of a financial institution, the method comprising:
providing to a customer of a financial institution access to a computer system comprising financial information and rewards data, and
presenting the financial information and rewards data to the customer of the financial institution in a presentation layer viewable by the customer.

2. The method according to claim 1, wherein the customer accesses the presentation layer using a web interface.

3. The method according to claim 2, wherein the web interface is a personal computer, a personal data assistant, or any device for accessing authenticated space.

4. The method according to claim 1, wherein the computer system of the financial institution is an online computer banking system.

5. The method according to claim 1, wherein the financial information and rewards data are obtained from sources including, but not limited to, online banking, bill pay, rewards engines, web channels, data aggregation, spending pattern reports, and a combination thereof.

6. The method according to claim 1, wherein the rewards data is presented to the customer using a computer software application tool.

7. The method according to claim 1, wherein the rewards data is in a form of rewards points.

8. The method according to claim 1, wherein the method further comprises integrating rewards data with financial information.

9. A computer system for integrating financial information and rewards data, the computer system comprising:
a web interface for providing a customer of a financial institution access to a webserver of a financial institution,
the webserver communicatively connected to an application server, wherein the application server comprises an online banking computer software application,
a database server communicatively connected to the application server, wherein the database server comprises a data extraction computer software application,
a database comprising rewards data and financial information communicatively connected to the database server, and
a presentation layer for presenting financial information and rewards data extracted from the database to the customer.

10. The computer system according to claim 9, wherein the financial information is online banking data.

11. The computer system according to claim 9, wherein the rewards data is in a form of rewards points.

12. A computer software application tool comprising rewards data of a customer of a financial institution extracted from a computer database for presentation of the rewards data of the customer in a statement to the customer, the customer having computer access to an online banking system of the financial institution.

13. A computer software application tool comprising a list of financial transactions and rewards data corresponding to the list of financial transactions of a customer of a financial institution for presentation to the customer, the customer having computer access to an online banking system of the financial institution.

14. A computer software application tool comprising data of rewards earned by a customer of a financial institution by transaction type for presentation to the customer, the customer having computer access to an online banking computer system of the financial institution.

15. The computer software application tool according to claim 14, wherein the transaction type is selected from the group consisting of an automated teller machine withdrawal, check, ACH, online bill payment, debit instrument purchase, and credit instrument purchase.
